(19) United States
(12) Patent Application Publication
(10) Pub. No.: US 2019/0370585 A1
(43) Pub. Date: Dec. 5, 2019

(54) IMAGE PROCESSING APPARATUS AND RECORDING MEDIUM

(71) Applicant: Konica Minolta, Inc., Tokyo (JP)

(72) Inventor: Yuhei KURIGATA, Tokyo (JP)

(21) Appl. No.: 16/418,057

(22) Filed: May 21, 2019

(30) Foreign Application Priority Data
May 30, 2018 (JP) 2018-103177

(51) Int. Cl. G06K 9/00; G06K 9/34; G06T 7/11

(52) U.S. Cl. CPC G06K 9/00973; G06T 2207/20021; G06T 7/11; G06K 9/34

(57) ABSTRACT

An image processing apparatus includes: a dynamic reconfigurator that is capable of dynamically reconfiguring a circuit related to one of multiple pieces of circuit information; a selector that divides image data into multiple regions and selects a piece of circuit information suitable for each of the multiple regions from the multiple pieces of circuit information; and an image processing control section that applies circuit information to the dynamic reconfigurator for each of the multiple regions, and performs image processing for each of the regions.

### CROSS REFERENCE TO RELATED APPLICATIONS

The present application claims priority under 35 U.S.C. § 119 to Japanese Patent Application No. 2018-103177, filed on May 30, 2018, is incorporated herein by reference in its entirety.

### BACKGROUND

### Technological Field

The present invention relates to an image processing apparatus and a recording medium.

### Description of Related Art

In recent years, processing apparatuses, such as digital application processor distributed network architectures (DAPDNAs) and field programmable gate arrays (FPGAs), in which part of circuit information (configuration data) is dynamically reconfigurable during circuit operation have been put into practical use. Such processing apparatuses are generally used in such a manner that the user switches circuits according to the function to be used, and they are actively used even in the field of image processing applied to image forming apparatuses and the like.

For example, Japanese Patent Application Laid-Open No. 2016-116171 discloses a technique for achieving image processing control when a job is executed in a system including a dynamically reconfigurable processing apparatus. With this technique, image processing circuits corresponding to respective multiple pages (image data) are reconfigured for each page to perform image processing control for each page.

### SUMMARY

By the way, since image data to be subject to image processing control includes image data with a large proportion of the image attribute and image data with a large proportion of the character attribute, the circuit size in the apparatus increases if image processing circuits are prepared for the respective attributes. For this reason, in such image processing of image data, it is preferable to reconfigure the image processing circuit dynamically according to the attribute that accounts for a large proportion in image data.

However, a region having a large proportion of image attribute and a region having a large proportion of the character attribute may coexist in image data, so that there may be a region in which the performance decreases depending on the image processing circuit applied to the image data. As a result, the performance of image processing control in the entire apparatus may be degraded depending on the image data.

An object of the present invention is to provide an image processing apparatus with which the circuit size in the apparatus can be reduced, while the performance of image processing control is improved, and a recording medium.

To achieve at least one of the abovementioned objects, according to an aspect of the present invention, an image processing apparatus reflecting one aspect of the present invention comprises:

a dynamic reconfigurator that is capable of dynamically reconfiguring a circuit related to one of multiple pieces of circuit information; and

a hardware processor that divides image data into multiple regions and selects a piece of circuit information suitable for each of the multiple regions from the multiple pieces of circuit information, wherein

the hardware processor applies the selected piece of circuit information to the dynamic reconfigurator for each of the multiple regions, and performs image processing for each of the regions.

To achieve at least one of the abovementioned objects, according to an aspect of the present invention, a non-transitory computer-readable recording medium reflecting one aspect of the present invention being a recording medium that stores therein a program for an image processing apparatus including a dynamic reconfigurator that is capable of dynamically reconfiguring a circuit related to one of multiple pieces of circuit information, the program causing a computer of the image processing apparatus to perform:

selection processing that divides image data into multiple regions and selects a piece of circuit information suitable for each of the multiple regions from the multiple pieces of circuit information; and

control processing that applies the piece of circuit information selected in the selection processing to the dynamic reconfigurator for each of the multiple regions, and performs image processing for each of the regions.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing an image forming apparatus to which an image processing apparatus according to an embodiment of the present invention is applied;

FIG. 2 is a block diagram showing an example of the configuration of an image processing apparatus according to this embodiment;

FIG. 3 is a graph showing a relationship between the proportion of the character attribute and the performance of image processing;

FIG. 4 is a diagram showing image data in which a character-attribute image and an image-attribute image coexist;

FIG. 5 is a diagram showing division of the image data shown in FIG. 4 into multiple regions;

FIG. 6 is a diagram showing a specific example of circuit stored in a circuit information storage section; and

FIG. 7 is a flow chart showing an example operation in image processing control in an image processing apparatus.

### DETAILED DESCRIPTION OF EMBODIMENTS

Hereinafter, one or more embodiments of the present invention will be described with reference to the drawings. However, the scope of the invention is not limited to the disclosed embodiments.

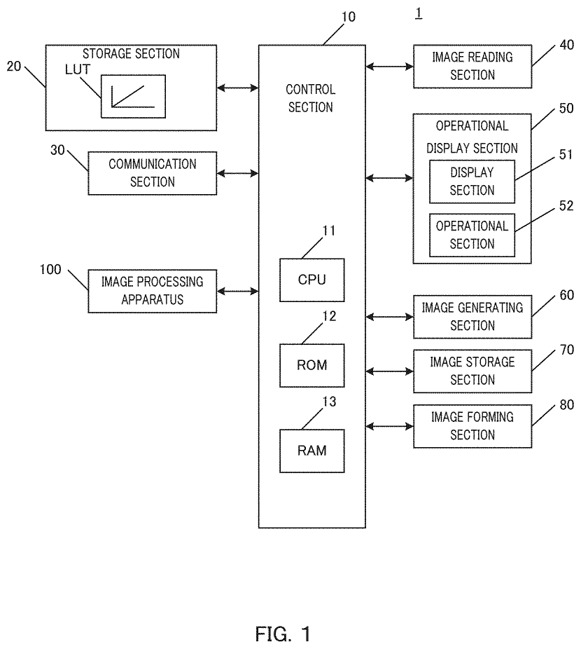

Embodiments of the present invention will now be described in detail with reference to the accompanying drawings. FIG. 1 is a diagram illustrating image forming apparatus 1 to which image processing apparatus 100 according to an embodiment of the present invention is applied.

As shown in FIG. 1, image forming apparatus 1 is, for example, an image forming apparatus based on the electrophotographic method or inkjet method. Image forming apparatus 1 includes control section 10, storage section 20, communication section 30, image reading section 40, operational display section 50, image generating section 60, image storage section 70, image forming section 80, and image processing apparatus 100.

Control section 10 includes central processing unit (CPU) 11, read only memory (ROM) 12, and random access memory (RAM) 13. CPU 11 reads a program from ROM 12 according to the processing content, loads it in RAM 13, and performs central control of the behavior of, for example, each block of image forming apparatus 1 in cooperation with the loaded program. At this time, a reference is made to various types of data stored in storage section 20. Storage section 20 is made up of, for example, a nonvolatile semiconductor memory (so-called flash memory) or hard disc drive.

Control section 10 transmits and receives various types of data to/from an external apparatus (for example, a personal computer) connected to a communication network, such as a local area network (LAN) or wide area network (WAN), through communication section 30. Control section 10 receives, for example, image data (input image data) described in the page description language (PDL) transmitted from the external apparatus, and forms an image based on the image data in a recording medium. Communication section 30 is made up of, for example, a communication control card, such as a LAN card.

Image reading section 40 includes an automatic document feeder apparatus, which is called auto document feeder (ADF), and a document image scanner apparatus (scanner). Image reading section 40 reads an image from a document placed on the document tray and converts it to image data.

Operational display section 50 is made up of, for example, a liquid crystal display (LCD) with a touch screen and functions as display section 51 and operational section 52. Display section 51 displays various operational screens, image states, and the operating conditions of each function, according to the display control signal input from control section 10. Operational section 52, which includes various operational keys, such as a numeric key pad and a start key, receives various input operations from the user and outputs an operational signal to control section 10.

Image generating section 60 performs rasterizing on PDL data received at communication section 30, and generates bitmapped image data. In image data, each pixel has grayscale values of four colors of C (cyan), M (magenta), Y (yellow), and K (black). A grayscale value is data representing an image gradation. For example, an 8-bit data value represents a gradation of a 0 to 255 grayscale level. The processing content in image generating section 60 can be accomplished by software processing for executing a program for generating images through a processor such as a CPU.

Image storage section 70 is a buffer memory for temporarily holding image data generated by image generating section 60, and is made up of, for example, a synchronous dynamic random access memory (SDRAM).

Image processing apparatus 100 reads image data related to each page from image storage section 70 concurrently with the timing of image formation, and performs image processing on the image data. The details of image processing apparatus 100 will be described later.

Image forming section 80 includes an image forming unit for each color of C, M, Y, and K, and forms an image in the recording medium according to the settings of the printing job. To be specific, image forming section 80 forms an image in the recording medium, based on the image data that has been subject to image processing in image processing apparatus 100 according to the grayscale values of the four colors of C, M, Y, and K.

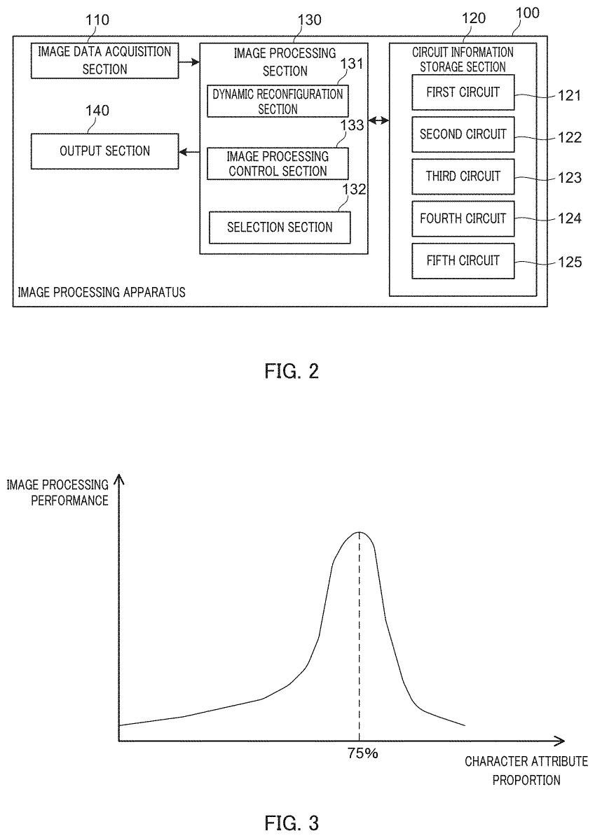

The details of image processing apparatus 100 will now be described. FIG. 2 is a block diagram showing an example of the configuration of image processing apparatus 100 according to this embodiment.

As shown in FIG. 2, image processing apparatus 100 is a processing apparatus in which the image processing circuit used for image processing of image data is dynamically reconfigurable. Image processing apparatus 100 includes image data acquisition section 110, circuit information storage section 120, image processing section 130, and output section 140.

Image data acquisition section 110 acquires image data for one page (for example, data of an image formed in one recording medium) from image storage section 70, and outputs it to image processing section 130.

Circuit information storage section 120 is made up of, for example, an SDRAM and stores multiple pieces of circuit information (configuration data) applied to dynamic reconfiguration section 131 (logic device) which will be described later.

Circuit information storage section 120 stores, for example, first circuit 121, second circuit 122, third circuit 123, fourth circuit 124, and fifth circuit 125 as the multiple pieces of circuit information.

First circuit 121, second circuit 122, third circuit 123, fourth circuit 124, and fifth circuit 125 are each made up of one or more arithmetic elements (logic circuits). At least one of the type and number of arithmetic elements differs among circuits 121, 122, 123, 124, and 125. For this reason, the performance of image processing (for example, processing rate) differs among first circuit 121, second circuit 122, third circuit 123, fourth circuit 124, and fifth circuit 125 depending on the ratio between the character attribute and the image attribute of image data to be subject to image processing.

It should be noted that the character attribute indicates an image consisting of only characters, and the image attribute indicates an image consisting of only images other than characters (for example, photographs).

To be specific, when the ratio between the character attribute and the image attribute is 100:0, the performance of first circuit 121 is at the maximum among all the circuits. When the ratio between the character attribute and the image attribute is 75:25, the performance of second circuit 122 is at the maximum among all the circuits. When the ratio between the character attribute and the image attribute is 50:50, the performance of third circuit 123 is at the maximum among all the circuits. When the ratio between the character attribute and the image attribute is 25:75, the performance of fourth circuit 124 is at the maximum among all the circuits. When the ratio between the character attribute and the image attribute is 0:100, the performance of fifth circuit 125 is at the maximum among all the circuits.

For example, in the case of second circuit 122, as shown in FIG. 3, the curve of the relationship of the performance of image processing with respect to the proportion of the character attribute is highest in the segment in which the proportion of the character attribute is 75%, and the performance decreases with distance from the proportion of 75%. Specific examples of circuits 121, 122, 123, 124, and 125 will be described later.

Image processing section 130 is a processor, such as a CPU, that performs image processing based on dynamically reconfigured circuit information, and includes a CPU, a ROM, a RAM. The CPU reads a program from the ROM according to the processing content and loads it in the RAM, and performs central control on the operation of image processing apparatus 100 in cooperation with the loaded program. Image processing section 130 includes dynamic reconfiguration section 131, selection section 132, and image processing control section 133.

Dynamic reconfiguration section 131 is a logic device (for example, an FPGA) in which circuits are dynamically reconfigurable. Dynamic reconfiguration section 131 acquires circuit information, which has been selected by selection section 132, from circuit information storage section 120, and adopts the acquired circuit information and is controlled so that image data is subject to image processing.

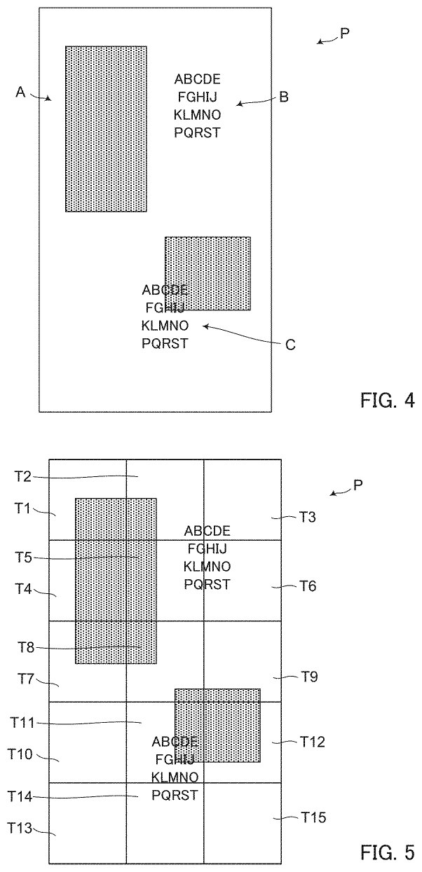

Selection section 132 divides image data into multiple regions, and among multiple pieces of circuit information, circuit information suitable for each of the multiple regions is selected. Here, as shown in FIG. 4, image data P may include data in which the image attribute and the character attribute coexist. It may include image data P including segment A of the image attribute only, segment B of the character attribute only, and segment C in which the image attribute and the character attribute overlap.

In this case, when image processing of image data for one page is performed with one piece of circuit information only, and the circuit information is suitable for the image attribute, for example, even if the performance of image processing is favorable in segment A, the performance of image processing decreases in segment B. For this reason, with such a configuration, due to the image processing in the segment in which the performance decreases for the circuit information, the entire performance in image processing decreases.

In the configuration in which the optimum circuit is reconfigured according to the position where image processing is performed, circuit information suitable for the image attribute can be used for segment A of the image attribute only, and circuit information suitable for the character attribute can be used for segment B of the character attribute only. However, in a segment in which the character attribute and image attribute of segment C overlap, for example, many boundaries exist between the segment of the character attribute and the segment of the image attribute, and the reconfiguration of circuit information may be needed each time of the reach at a boundary. In this case, reconfiguration is frequently performed in dynamic reconfiguration section 131, so that the performance of image processing may further decrease, considering, for example, the time required for transmission of circuit information from circuit information storage section 120 to image processing section 130 upon reconfiguration.

For this reason, in this embodiment, selection section 132 first divides image data into, for example, 15 regions T1 to T15 in a 3 by 5 array as shown in FIG. 5. Subsequently, selection section 132 selects a circuit suitable for a region to be subject to image processing in image processing section 130 (a processing target region), that is, the circuit information with which the performance of image processing section 130 becomes maximum in the processing target region.

To be specific, when the proportion of the character attribute is 100% (when the proportion of the image attribute is 0%), selection section 132 selects first circuit 121. When the proportion of the character attribute is greater than 62.5% and less than 100% (when the proportion of the image attribute is greater than 0% and less than 37.5%), selection section 132 selects second circuit 122. When the proportion of the character attribute is greater than or equal to 37.5% and less than or equal to 62.5% (when the proportion of the image attribute is greater than or equal to 37.5% and less than or equal to 62.5%), selection section 132 selects third circuit 123. When the proportion of the character attribute is greater than 0% and less than 37.5% (when the proportion of the image attribute is greater than 62.5% and less than 100%), selection section 132 selects fourth circuit 124. When the proportion of the character attribute is 0% (the proportion of the image attribute is 100%), selection section 132 selects fifth circuit 125.

It should be noted that the base attribute (either character nor image attribute), which does not require particular processing with a circuit, is not included in the proportion of the character attribute or the proportion of the image attribute. For example, in the case where no character attribute exists and the image attribute and the base attribute coexist within the region, the proportion of the character attribute can be regarded as 0%, and the proportion of the image attribute can be regarded as 100%. In the case where no image attribute exists and the character attribute and the base attribute coexist within the region, the proportion of the character attribute can be regarded as 100%, and the proportion of the image attribute can be regarded as 0%. In the case where the image attribute, the character attribute, and the base attribute coexist, the base attribute may be included in the image attribute or the character attribute.

In the example shown in FIG. 5, for example, for region T1, which includes the image attribute only, fifth circuit 125 with which the performance is at the maximum when the proportion of the image attribute is 100% is selected. For region T6, which includes the character attribute only, first circuit 121 with which the performance is at the maximum when the proportion of the character attribute is 100% is selected. For region T11, which includes the character attribute and the image attribute in approximately equal proportion, third circuit 123 with which the performance becomes maximum with this ratio is selected.

Image processing control section 133 applies circuit information selected by selection section 132 to dynamic reconfiguration section 131 for each of the multiple regions, and performs image processing for each region. To be specific, after image processing for processing target region in image processing section 130, and before image processing for the next processing target region, the circuit of dynamic reconfiguration section 131 is reconfigured, and image processing for the next processing target region is performed through the reconfigured circuit. In other words, image processing control section 133 sequentially performs image processing for divided multiple regions T1 to T15.

For example, image processing control section 133 sequentially performs image processing from left to right: it first performs image processing for region T1 at the upper left corner in the image data, and then image processing for region T2 at its right. Subsequently, upon completion of the image processing for region T3 at the upper right corner, image processing control section 133 performs image processing for region T4 that is the second top region in the leftmost column. In other words, image processing section 130 performs image processing through the raster method for regions T1, T2, T3, T4, T5, T6, T7, T8, T9, T10, T11, T12, T13, T14, and T15 in the order presented.

Dividing image data into multiple regions in this manner can limit the number of times of dynamic reconfiguration of circuits to the number of divided regions. Hence, frequent circuit reconfiguration at boundaries between the character attribute and the image attribute can be suppressed.

In addition, since the circuit with which the performance of image processing becomes maximum is selected according to the ratio between the character attribute and the image attribute in that region, and is used for image processing, the efficiency of image processing in each region can be improved, which improves the entire performance of image processing.

With a configuration in which image processing is performed without image reconfiguration, the processing rate may greatly differ among a region with a large proportion of the character attribute, a region with a large proportion of the image attribute, and a region including the character attribute and the image attribute in equal proportion, which lowers the entire performance of image processing.

In this embodiment, however, the circuit with which the performance becomes maximum in each region is selected to perform image processing, so that the efficiency of image processing in each region can be improved, which improves the entire performance of image processing.

Besides, with a configuration in which multiple circuits are provided for the respective attributes, during use of a circuit suitable for a segment with only the character attribute, one of the circuits is unused during image processing, for example, a circuit suitable for a segment with only the image attribute is unused. In other words, an extra space for the circuit that is always unused needs to be ensured, which increases the circuit size in the apparatus.

In this embodiment, however, circuit reconfiguration is performed for each region, eliminating the need for ensuring the space for the unused circuit and thus reducing the circuit size in the apparatus.

Output section 140 outputs image data for which image processing has been completed in image processing section 130 to image storage section 70. Image data output to image storage section 70 is formed by image forming section 80 into an image in the recording medium.

Output section 140 may sequentially give an output to image storage section 70 for regions for which image processing has been completed in image processing section 130. For example, output section 140 may output image data for which image processing has been completed to image storage section 70 for regions T1, T2, T3, T4, T5, T6, T7, T8, T9, T10, T11, T12, T13, T14, and T15 in the order presented. Since image forming section 80 forms images in the recording medium in the output-based order, formation of an image in the recording medium can be performed during image processing of image data, so that efficiency of formation of an image can be improved in image forming apparatus 1 (the apparatus to which image processing apparatus 100 is applied).

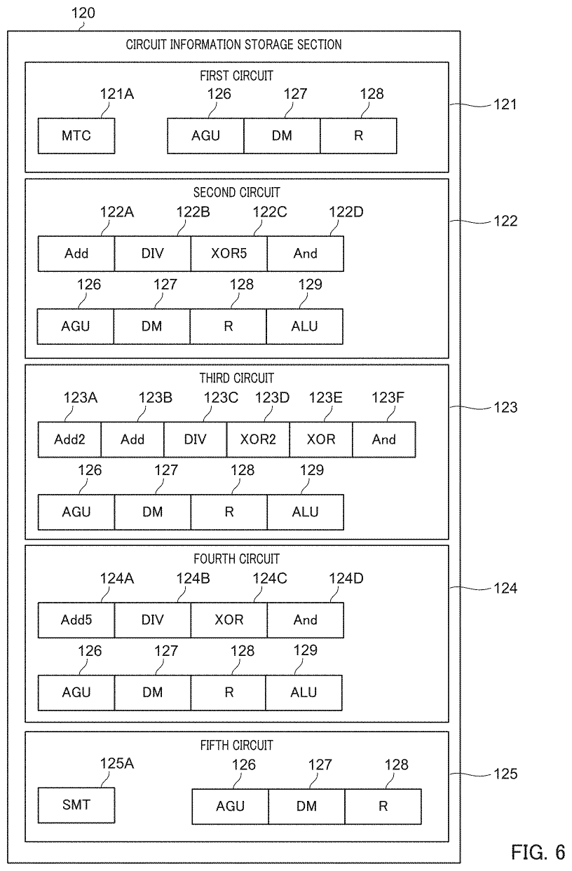

Specific examples of circuits 121, 122, 123, 124, and 125 will now be described with reference to FIG. 6. FIG. 6 is a diagram showing a specific example of circuit stored in circuit information storage section 120. It should be noted that FIG. 6 shows only elements different in circuits, and omits the other elements.

Image processing of the character attribute is performed by pattern matching processing, for example. To be specific, it is achieved by determining whether the array pattern of pixels around a target pixel in the pixels constituting the image of the character attribute matches a predetermined array pattern of pixels to detect whether the target pixel is a pixel constituting an edge section. Such pattern matching processing is performed by an XOR (exclusive or) operation on pixels corresponding to each other.

Image processing of the image attribute is performed by smoothing processing, for example. To be specific, it is performed by calculating the average value within a local region around a target pixel in the pixels constituting the image of the image attribute and setting the average value as the value of the target pixel. Such smoothing processing is performed by summing and dividing pixels corresponding to each other.

As is clear from above, circuits used for arithmetic are slightly different between image processing of the character attribute and image processing of the image attribute, so that, considering the arithmetic efficiency, an optimum circuit needs to be used according to the ratio between the character attribute and the image attribute in image data. For this reason, in this embodiment, based on the circuit information stored in circuit information storage section 120, a circuit suitable for a processing target region is used for image processing in the processing target region according to the ratio between the character attribute and the image attribute in the image data. Accordingly, the arithmetic efficiency in the image processing for the processing target region is improved, thereby improving the performance of the image processing.

First circuit 121 is the circuit with which the highest performance is obtained in image processing of the character attribute only, and includes arithmetic element 121A (MTC). Arithmetic element 121A is a pattern matching-dedicated circuit that performs only pattern matching processing and is incapable of smoothing processing. In other words, first circuit 121 is capable of image processing of the character attribute through one circuit operation (one cycle), and is incapable of image processing of the image attribute.

Second circuit 122 is the circuit with which the highest performance is obtained in image processing of an image in which the proportion of the image of the character attribute is comparatively large, and includes arithmetic element 122A (Add), arithmetic element 122B (DIV), arithmetic element 122C (XOR5), and arithmetic element 122D (And).

Arithmetic element 122A is an adder circuit capable of addition processing. Arithmetic element 122B is a divider circuit capable of division processing. Arithmetic element 122C is a circuit including five circuits capable of XOR operations. In other words, arithmetic element 122C is a circuit that can perform five XOR operations at the same time. Arithmetic element 122D is a circuit capable of OR operations.

Although the number of times of addition processing in smoothing processing is five and the number of times of XOR operations in pattern matching processing is five in this embodiment, these numbers can be arbitrarily changed according to the number of peripheral pixels used for arithmetic related to the target pixel.

When image processing of the character attribute is needed, second circuit 122 performs five XOR operations through arithmetic element 122C, for example, and then an OR operation on the value obtained by the XOR operations through arithmetic element 122D. In other words, when image processing of the character attribute is needed, second circuit 122 can perform two circuit operations (two cycles) to achieve image processing of the character attribute.

In addition, when image processing of the image attribute is needed, second circuit 122 performs, for example, addition processing five times through arithmetic element 122A, and then divides the value obtained by the addition processing by 5 through arithmetic element 122B. In other words, when image processing of the image attribute is needed, second circuit 122 can perform a total of six circuit operations (six cycles) including five times of addition processing and one time of division processing to achieve image processing of the image attribute. As is clear from these, second circuit 122, in which the processing rate of image processing of the character attribute is higher than the processing rate of image processing of the image attribute, is a circuit that places more weight on image processing of the character attribute.

Third circuit 123 is the circuit with which the performance becomes maximum in image processing of an image in which the proportion of the image of the character attribute and the proportion of the image of the image attribute are equal. Third circuit 123 includes arithmetic element 123A (Add2), arithmetic element 123B (Add), arithmetic element 123C (DIV), arithmetic element 123D (XOR2), arithmetic element 123E (XOR), and arithmetic element 123F (And).

Arithmetic elements 123A and 123B are adder circuits capable of addition processing. In addition, arithmetic element 123A is a circuit that can perform two pieces of addition processing at the same time. Arithmetic element 123C is a divider circuit capable of division processing. Arithmetic elements 123D and 123E are circuits capable of XOR operations. In addition, arithmetic element 123D is a circuit that can perform two XOR operations at the same time. Arithmetic element 123F is a circuit capable of OR operations.

When image processing of the character attribute is needed, third circuit 123 performs two XOR operations through arithmetic element 123D, for example, and one XOR operation through arithmetic element 123E, and then an OR operation on the value obtained by the XOR operations through arithmetic element 123F. In other words, when image processing of the character attribute is needed, third circuit 123 can perform a total of four circuit operations (four cycles) including two operations of arithmetic element 123D, one operation of arithmetic element 123E, and one operation of arithmetic element 123F to achieve image processing of the character attribute.

In addition, when image processing of the image attribute is needed, third circuit 123 performs addition processing twice through arithmetic element 123A and addition processing once through arithmetic element 123B, and then divides the value obtained by the addition processing by 5 through arithmetic element 123C. In other words, when image processing of the image attribute is needed, third circuit 123 can perform a total of four circuit operations (four cycles) including three times of addition processing and one time of division processing to achieve image processing of the image attribute. As is clear from these, third circuit 123, in which the processing rate of image processing of the character attribute is equal to the processing rate of image processing of the image attribute, is a circuit that places the same weight on image processing of the character attribute and image processing of the image attribute.

Fourth circuit 124 is the circuit with which the highest performance is obtained in image processing of an image in which the proportion of the image of the image attribute is comparatively large, and includes arithmetic element 124A (Adds), arithmetic element 124B (DIV), arithmetic element 124C (XOR), and arithmetic element 124D (And).

Arithmetic element 124A is an adder circuit that can perform five times of addition processing at the same time. Arithmetic element 124B is a divider circuit capable of division processing. Arithmetic element 124C is a circuit capable of XOR operations. Arithmetic element 124D is a circuit capable of OR operations.

When image processing of the character attribute is needed, fourth circuit 124 performs, for example, five XOR operations through arithmetic element 124C, and then an OR operation on the value obtained by the XOR operations through arithmetic element 124D. In other words, when image processing of the character attribute is needed, fourth circuit 124 can perform a total of six circuit operations (six cycles) including five XOR operations and one OR operation to achieve image processing of the character attribute.

In addition, when image processing of the image attribute is needed, fourth circuit 124 performs, for example, addition processing five times through arithmetic element 124A, and then divides the value obtained by the addition processing by 5 through arithmetic element 124B. In other words, when image processing of the image attribute is needed, fourth circuit 124 can perform a total of two circuit operations (two cycles) including one time of processing in arithmetic element 124A and one time of division processing to achieve image processing of the image attribute. As is clear from these, fourth circuit 124, in which the processing rate of image processing of the image attribute is higher than the processing rate of image processing of the character attribute, is a circuit that places more weight on image processing of the image attribute.

Fifth circuit 125 is the circuit with which the highest performance is obtained in image processing of the image attribute only, and includes arithmetic element 125A (SMT). Arithmetic element 125A is a pattern smoothing-dedicated circuit that performs only smoothing processing and is incapable of pattern matching processing. In other words, fifth circuit 125 is capable of image processing of the image attribute through one circuit operation (one cycle), and is incapable of image processing of the character attribute.

Further, each of circuits 121, 122, 123, 124, and 125 is provided with address generation unit 126 (AGU), data memory 127 (DM), and register file 128(R). Second circuit 122, third circuit 123, and fourth circuit 124 are provided with, in addition to address generation unit 126, data memory 127, and register file 128, arithmetic unit 129 (ALU). Since data transmission and the like are performed between these structures and the arithmetic element of each circuit, image processing in each circuit is performed.

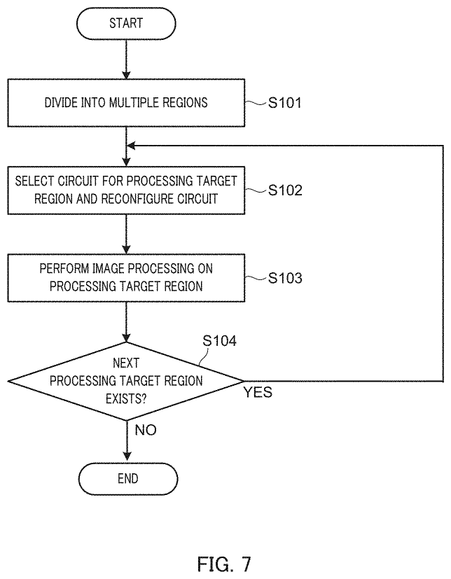

An example operation of image processing apparatus 100 in execution of image processing control will now be explained. FIG. 7 is a flow chart showing an example operation of image processing control in image processing apparatus 100. The processing in FIG. 7 is carried out as appropriate when control section 10 receives an instruction to execute a printing job, for example.

As shown in FIG. 7, image processing section 130 divides the image data acquired by image data acquisition section 110 into multiple regions (Step S101). Next, image processing section 130 selects the circuit of the processing target region and dynamically reconfigures the circuit (Step S102).

Image processing section 130 performs image processing on the processing target region (Step S103). Subsequently, image processing section 130 determines whether the next processing target region exists (Step S104).

If the next processing target region exists according to the determination results (Step S104, YES), the process returns to Step S102. On the contrary, if the next processing target region does not exist (Step S104, NO), the control ends.

In this embodiment with such a configuration, since the circuit with which the performance of image processing becomes maximum is selected according to the ratio between the character attribute and the image attribute in each divided region, and is used for image processing, the efficiency of image processing in each region can be improved, which improves the entire performance of image processing.

Further, since circuit information suitable for each region is selected and the circuit information is dynamically reconfigured, the circuit size can be made smaller than that in a configuration in which processing circuits are provided for the respective attributes.

Further, since image data is divided into multiple regions, the number of times of dynamic reconfiguration of circuits can be limited to the number of divided regions. Hence, frequent circuit reconfiguration at boundaries between the character attribute and the image attribute can be suppressed, which can further improve the performance of image processing.

Further, since the circuit with which the performance becomes maximum in each region is selected to perform image processing, as compared with the configuration in which image processing is performed without image reconfiguration, the processing rate can be prevented from greatly differing according to the attribute of the region, so that the entire performance of image processing can be improved.

Although image processing apparatus 100 includes circuit information storage section 120 in the above-described embodiment, this is not necessarily the case in the present invention and circuit information may be transmitted from a storage section outside image processing apparatus 100 to dynamic reconfiguration section 131.

Further, although the number of regions into which image data is divided is set to 15 in the above-described embodiment, this is not necessarily the case in the present invention and the number of regions may be set to other than 15. For example, when the performance of image processing needs to be improved, a larger number of regions may be set.

Further, although five pieces of circuit information are used for dynamic reconfiguration in the above-described embodiment, this is not necessarily the case in the present invention and dynamic reconfiguration may be performed using any number of pieces of circuit information other than five. For example, when the performance of image processing needs to be improved, a larger number of pieces of circuit information may be set.

Further, although image processing is performed in image processing apparatus 100 by using the circuits shown in FIG. 6 in the above-described embodiment, this is not necessarily the case in the present invention and the image processing may be performed using circuits other than the circuits shown in FIG. 6.

Further, although dynamic reconfiguration section 131, selection section 132, and image processing control section 133 are incorporated in image processing section 130 in the above-described embodiment, this is not necessarily the case in the present invention and they may be separately provided.

Further, although the image attribute and the character attribute are illustrated as multiple attributes of an image in the above-described embodiment, this is not necessarily the case in the present invention and, for example, three or more attributes may be used as the multiple attributes of the image.

Further, although one including an FPGA is illustrated as dynamic reconfiguration section 131 in the above-described embodiment, this is not necessarily the case in the present invention and a logic device other than an FPGA may be included therein.

Further, although image forming apparatus 1 is illustrated as an apparatus to which image processing apparatus 100 is applied in the above-described embodiment, this is not necessarily the case in the present invention and the apparatus may be other than an image forming apparatus.

Aside from that, the above embodiments merely show specific examples for implementing the present invention and the technical scope of the present invention should not be construed as being limited because of them. In other words, the present invention can be implemented in various modes without departing from the spirit or main features of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing apparatus, comprising:
a dynamic reconfigurator that is capable of dynamically reconfiguring a circuit related to one of multiple pieces of circuit information; and
a hardware processor that divides image data into multiple regions and selects a piece of circuit information suitable for each of the multiple regions from the multiple pieces of circuit information, wherein
the hardware processor applies the selected piece of circuit information to the dynamic reconfigurator for each of the multiple regions, and performs image processing for each of the regions.

2. The image processing apparatus according to claim 1, wherein the hardware processor selects, from the multiple pieces of circuit information, a piece of circuit information that maximizes performance of the image processing for a region to be subject to processing.

3. The image processing apparatus according to claim 1, wherein the hardware processor determines a piece of circuit information to be applied to the dynamic reconfigurator based on a ratio of multiple attributes of an image in a region to be subject to processing.

4. The image processing apparatus according to claim 1, wherein the dynamic reconfigurator acquires the piece of circuit information selected by the hardware processor.

5. The image processing apparatus according to claim 1, wherein the hardware processor sequentially outputs the regions that have been subject to image processing to a recording medium.

6. The image processing apparatus according to claim 1, wherein
the piece of circuit information is composed of one or more arithmetic elements, and
at least one of s type and number of the one or more arithmetic arithmetic elements differs among the multiple pieces of circuit information.

7. A non-transitory computer-readable recording medium that stores therein a program for an image processing apparatus including a dynamic reconfigurator that is capable of dynamically reconfiguring a circuit related to one of multiple pieces of circuit information, the program causing a computer of the image processing apparatus to perform:
selection processing that divides image data into multiple regions and selects a piece of circuit information suitable for each of the multiple regions from the multiple pieces of circuit information; and
control processing that applies the piece of circuit information selected in the selection processing to the dynamic reconfigurator for each of the multiple regions, and performs image processing for each of the regions.
